(19) United States
(12) Patent Application Publication
(10) Pub. No.: US 2022/0114555 A1
(43) Pub. Date: Apr. 14, 2022

(54) DETERMINATION AND NOTIFICATION OF SHIPPING DOCK DETENTION DELAY EVENTS FOR REGULATED AND UNREGULATED DRIVERS

(71) Applicant: J.J. Keller & Associates, Inc., Neenah, WI (US)

(72) Inventors: Steven Duane Myers, Lee's Summit, MO (US); Thomas Andrew Ditzler, Neenah, WI (US)

(21) Appl. No.: 17/066,109

(22) Filed: Oct. 8, 2020

(51) Int. Cl. G06Q 10/10; G06Q 50/28; G01S 19/01; H04W 4/40; H04W 4/024

(52) U.S. Cl. CPC G06Q 10/1091; G06Q 50/28; H04W 4/024; G01S 19/01; H04W 4/40; G06Q 10/107

(57) ABSTRACT

The present invention relates generally to the determination and the notification of shipping dock detention delays for regulated and non-regulated vehicle drivers.

### BACKGROUND

Shipping dock detention periods can negatively impact a regulated commercial driver's hours-of-service (HOS) cycles which can lead to lost efficiency, to increased costs and to safety issues. Long dock detention times affect a driver's schedule, meaning less income for the driver. A Department of Transportation report estimates dock detention times can reduce driver income by $1.1 billion to $1.3 billion for for-hire commercial motor vehicle drivers in the truckload sector. The Government Accountability Office found “about 65 percent of drivers reported lost revenue as a result of detention time from either missing an opportunity to secure another load or paying late fees to the shipper.”

Drivers running late on deadlines may become frustrated and may compensate for lost time with dangerous driving behavior such as driving while fatigued, speeding, and violating HOS requirements. The Office of Inspector General released a trucking-industry report related to prolonged shipping dock wait times confirming the problem. The report estimated that a 15-minute added wait time leads to a 6.2% rise in crash rates. It is not uncommon for drivers to experience much longer dock detention periods.

Prior art methods and devices gather and report on general dock detention trends and statistics, however, most of this reporting data is subjective, comes from hearsay and memories of unhappy drivers, and is not accurate. Other prior art methods rely upon the driver to remember to launch a specialty application upon encountering a dock detention event, rely upon the driver to record the detention period, rely upon the driver to enter or select an individual dock address, company name, latitude/longitude to identify location and provide no automation of any metrics to ensure accuracy of location and duration of the dock detention events. This subjective data is prone to inaccuracies.

### SUMMARY

One aspect of the invention includes a method for automatically determining the start of a dock detention delay event for regulated and non-regulated drivers of a vehicle comprising the steps of providing a mobile device; sending a driver's planned route to the mobile device, the planned route includes at least one planned dock location; comparing current GPS coordinates of the vehicle to the planned route; determining if the vehicle has stopped for more than a predetermined period of time; and determining a dock detention delay event start when the predetermined period of time has elapsed and the GPS coordinates correlate to a planned dock location.

Another aspect of the invention includes a method for determining a dock detention delay time period for regulated and unregulated drivers of a vehicle comprising the steps of providing a mobile device; sending a driver's planned route to the mobile device, the planned route includes at least one planned dock location; comparing current GPS coordinates of the vehicle to the planned route; determining if the vehicle has stopped for more than a predetermined period of time; determining a dock detention delay event start when the predetermined period of time has elapsed and the GPS coordinates correlate to a planned dock location; determining a dock detention delay event stop when the vehicle is no longer at the planned dock location; and calculating a dock detention period using the dock detention event stop and start.

Another aspect of the invention includes a method for providing notifications relating to a dock detention delay event when there is a predetermined dock detention time limit established comprising the steps of determining the start of a dock detention delay event; determining the stop of a dock detention delay event; and notifying at least one stakeholder of at least one of the following: as the dock detention delay event starts; as the predetermined dock detention time limit is drawing near; as the predetermined dock detention time limit has been reached; and as the predetermined dock detention time period limit has been exceeded.

Other aspects of the invention will become apparent by consideration of the detailed description and accompanying drawings.

### BRIEF DESCRIPTION OF THE DRAWINGS

FIG. 1 is a schematic view of a vehicle in three different positions at a shipping dock facility.

FIG. 2 is a schematic view of a vehicle, a mobile device and a remote database.

FIG. 3 is a flowchart of the operation of a method to detect the start and stop of a dock detention delay event.

FIG. 4 is flowchart of the operation of a method for the determination of and notification to stakeholders of a dock detention delay event.

Before any embodiments of the invention are explained in detail, it is to be understood that the invention is not limited in its application to the details of constructions and the arrangement of components set forth in the following description or illustrated in the drawings. The invention is capable of other embodiments and of being practiced or of being carried out in various ways.

### DETAILED DESCRIPTION

A method for incorporating dock detention start/stop times into a driver's hours-of-service (HOS) reporting process is disclosed in pending U.S. application Ser. No. 16/669,988 titled SHIPPING DOCK DETENTION DATA filed on Oct. 31, 2020, which is herein incorporated by reference.

The present invention automates the gathering dock detention data for regulated and non-regulated drivers and provides relevant real-time notifications to third parties, such as drivers, dispatchers and shippers/receivers, that contracted or other desired dock-detention delay times are approaching, have been reached and/or have been exceeded for any given cargo pickup/delivery situation.

Non-regulated drivers, such as local delivery drivers, are not required to have HOS reporting. Many local delivery drivers, such as for beverage or for perishable produce for example, experience dock detention situations thereby impacting their pay and length of their working day. The invention does not require a driver to have an ELD or HOS application. Rather, the invention relates to auto-detecting when a driver may be in a dock detention delay situation.

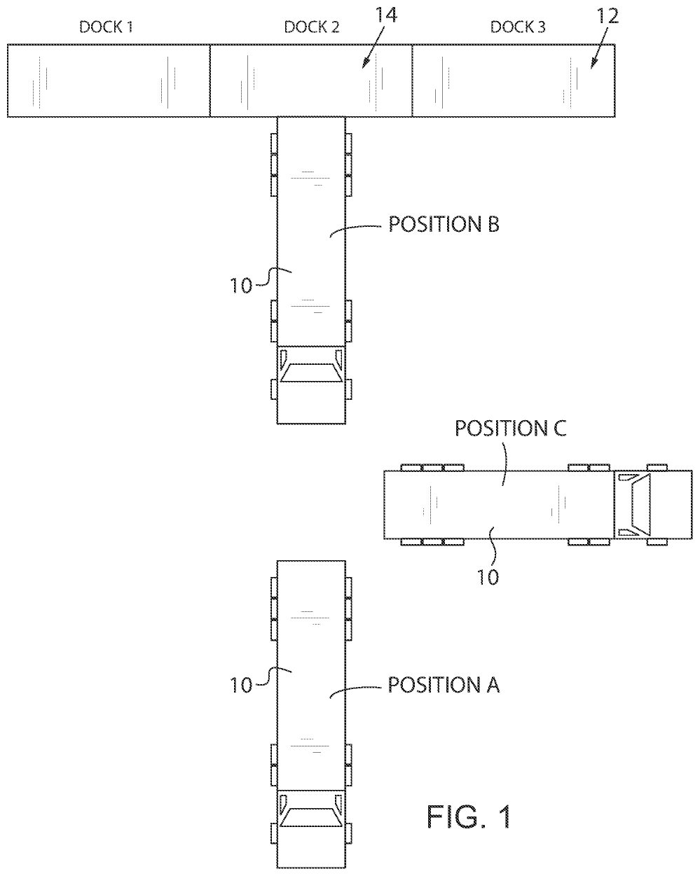

With reference to FIG. 1, there is shown a vehicle 10 (at a position A) that has arrived at a shipping dock facility 12 and is waiting for an individual shipping dock 14 to become available. The time period the driver waits to access the specific dock 14 is termed the staging period. When the waited-for dock 14 is free and the vehicle 10 is allowed access, the driver moves the vehicle 10 into the dock 14 (at a position B). The time period the driver waits in the dock 14 before the unloading begins is termed the waiting period such as waiting for unloading personnel to arrive. The unloading of the vehicle 10 then begins and ends. The time period during which the vehicle 10 is being unloaded until the vehicle 10 moves away from the dock 14 (at a Position C) is termed the unloading period. The detention period is preferably made up the staging period, the waiting period and the unloading period, however, it may also be a subset of those periods.

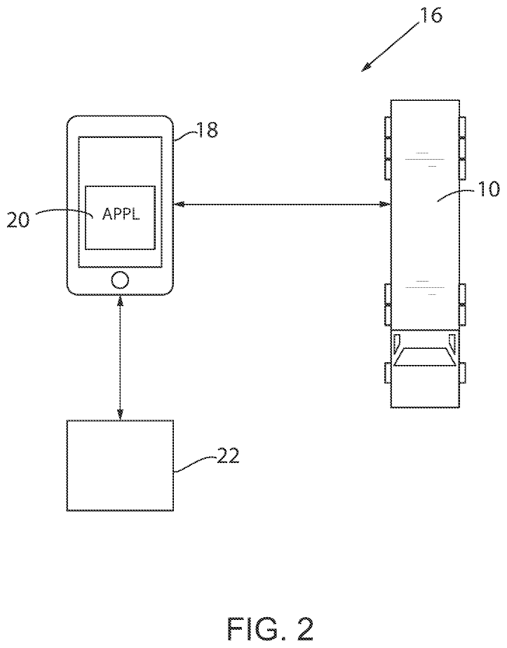

Turning to FIG. 2, a dock detention determination system 16 for the automated gathering of dock detention data for regulated and unregulated drivers is shown. The system 16 includes the vehicle 10, a mobile device 18, an application 20 running on the mobile device 18 and a remote database 22. The application 20 running on the mobile device 18 prevents the need for the driver to remember to run the application 20 at the start of his/her shift and can prompt the driver to verify that a dock detention delay event has started. The system 16 automates the start of detecting of a docket detention delay event for regulated and non-regulated drivers using technologies available on the mobile device 18 such as GPS capability, an accelerometer and potentially other technologies available.

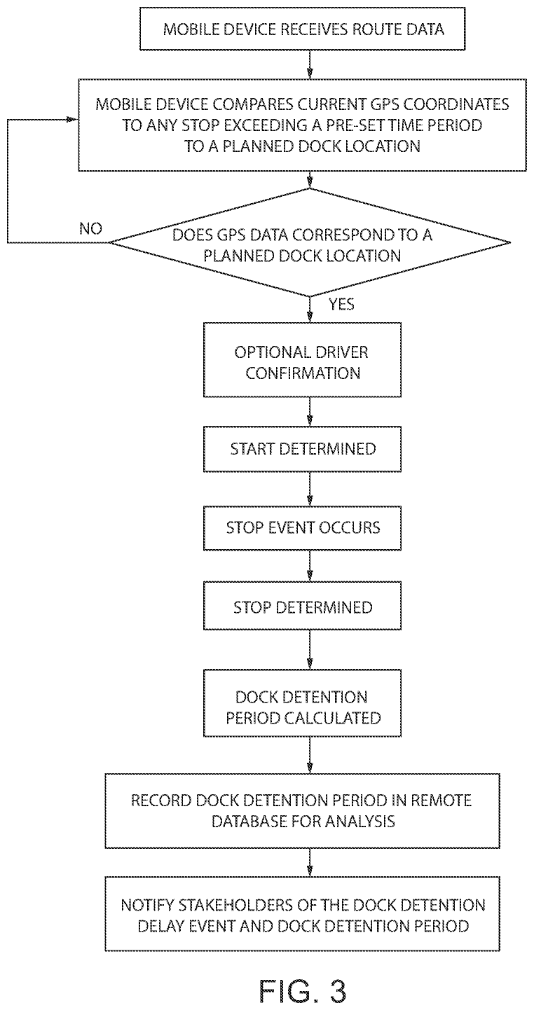

As illustrated in FIG. 3, a process is described to detect the start and the stop of a dock detention delay event. The automatic detection of the start of a dock detention delay event is determined by using a driver's intended/assigned route and stop information to determine the start of a dock detention delay event. The mobile device receives the intended/assigned route information from a source such as manual entry into the mobile device, bill of lading information or dispatch information, for example, however, other source can also be utilized, When the driver is in the vehicle on the route, the mobile device compares the GPS coordinates of any stop exceeding a predetermined amount of time, such as two minutes for example, to the GPS coordinates of all planned delivery/pickup dock locations. These may be reverse geo-coded addresses, navigation app coordinates, and the like. If there is a match of a planned dock location and the actual stop location, the mobile device will determine that a dock detention delay event has started. Optionally, the mobile device can prompt the driver to confirm the start of the dock detention delay event.

The end of a dock detention delay event is automatically detected without driver input by detecting a stop event. The stop event can include (a) the driver's resumption of the vehicle route by detecting a vehicle speed above a certain mph, for example 5 mph; (b) the vehicle being a distance from the dock as determined by GPS data; or (c) other such automated mechanisms that indicate the driver and vehicle are no longer at the individual dock.

Upon a stop event being detected, the dock detention period can be calculated. The dock detention period can be recorded in the remote database for later reporting and analysis. Notifications of the dock detention delay event and/or dock detention period can be sent to stakeholders such drivers, dispatchers, shippers/receivers and/or dock facilities. Optionally, the dock detention period can be validated by the driver approving the calculated dock detention period.

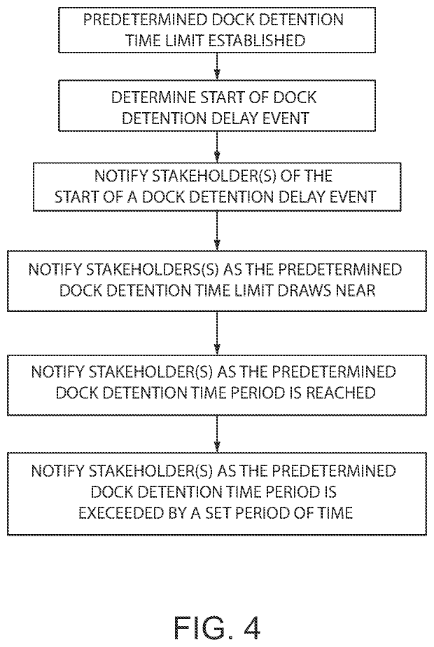

Referring now to FIG. 4, a process is described for the determination of and the notification to stakeholders of a dock detention event where there is a predetermined dock detention delay time limit. The predetermined dock detention delay time limit is established as between the stakeholders such as the dock facility and the shipper/receiver for example. The start of a dock detention delay event is determined as described above in FIG. 3. The stakeholder(s) can be notified that the driver and vehicle have arrived at a dock and optionally set forth the predetermined dock detention delay time limit Such notification can be in the form of an email, a text, a telephone call or other communication method. The stakeholder(s) can be notified as the predetermined dock detention delay time limit draws near, such as within 30 minutes for example, however, any desired time period remaining can be utilized as desired for a particular circumstance. The stakeholder(s) can be notified as the predetermined dock detention delay time limit has been reached. The stakeholder(s) can be notified as the predetermined dock detention delay time period has been exceeded by a desired period of time, such as 30 minute increments for example, however, other time periods can be utilized as desired for a particular circumstance.

With such a determination and notification process for dock delay detention events, stakeholders in the logistics chain can receive the real time notifications. Shippers/receivers can receive such real time notifications in order to better prioritize dock access for loading/unloading of cargo. Cargo carriers can receive such real time notifications in order to advise a driver as to actions to be taken (i.e., drop trailer, proceed to next location and/or continue to wait), in order to contact the shipper/receiver as to situation, in order to record incidents for later compensation, settlement, and/or like actions. Third party logistics can receive notifications in order to determine preferred shippers based on dock detention delay metrics and/or to record incident for later compensation settlement, and the like.

Various features and advantages of the invention are set forth in the following claims.

1. A method for automatically determining the start of a dock detention delay event for regulated and non-regulated drivers of a vehicle comprising the steps:
providing a mobile device;
sending a driver's planned route to the mobile device, the planned route includes at least one planned dock location;
comparing current GPS coordinates of the vehicle to the planned route;
determining if the vehicle has stopped for more than a predetermined period of time; and
determining a dock detention delay event start when the predetermined period of time has elapsed and the GPS coordinates correlate to a planned dock location.

2. The method of claim 1 wherein the mobile device is a mobile phone.

3. The method of claim 1 and further including the step of notifying at least one entity of the dock detention delay event start.

4. A method for determining a dock detention delay time period for regulated and unregulated drivers of a vehicle comprising the steps:
providing a mobile device;
sending a driver's planned route to the mobile device, the planned route includes at least one planned dock location;
comparing current GPS coordinates of the vehicle to the planned route;
determining if the vehicle has stopped for more than a predetermined period of time;
determining a dock detention delay event start when the predetermined period of time has elapsed and the GPS coordinates correlate to a planned dock location;
determining a dock detention delay event stop when the vehicle is no longer at the planned dock location; and
calculating a dock detention period using the dock detention event stop and start.

5. The method of claim 4 and further including the step of recording the dock detention period in a database.

6. The method of claim 4 and further including the step of notifying at least one entity of the dock detention period.

7. A method for providing notifications relating to a dock detention delay event when there is a predetermined dock detention time limit established comprising the steps:
determining the start of a dock detention delay event;
determining the stop of a dock detention delay event; and
notifying at least one stakeholder of at least one of the following:
as the dock detention delay event starts;
as the predetermined dock detention time limit is drawing near;
as the predetermined dock detention time limit has been reached; and
as the predetermined dock detention time period limit has been exceeded.

8. The method of claim 7 where the start and stop of the dock detention delay event are determined automatically without driver input.

9. The method of claim 7 where the stakeholders include the driver, the dispatcher, the shipper/receiver and dock facility.

10. The method of claim 7 wherein the notifying step includes at least one of emailing, texting, calling and instant messaging.
